(19) United States
(12) Patent Application Publication
(10) Pub. No.: US 2005/0082958 A1
(43) Pub. Date: Apr. 21, 2005

(54) Plasma display panel

(76) Inventors: Yao Ching Su, Tauyuan City (TW); Shiang-Wen Wan, Sanchong City (TW)

Correspondence Address: DUANE MORRIS, LLP;IP DEPARTMENT, ONE LIBERTY PLACE, PHILADELPHIA, PA, 19103-7396, US

(21) Appl. No.: 10/689,152

(22) Filed: Oct. 20, 2003

(51) Int. Cl. H01J 17/49

(52) U.S. Cl. 313/292; 313/582

(57) ABSTRACT

An alternating current drive type plasma display panel (AC PDP) having a discharge cell-defining barrier structure with minimized firing shrinkage distortions provided by selecting different line widths for the barrier rib row and column members, and/or adding supplementary barrier rib members adjacent the peripheral edges of the barrier rib structure, and/or reducing the zig-zag distances of the edge profile of the barrier rib structure.

### FIELD OF THE INVENTION

This invention relates to plasma display panels. More particularly, this invention relates to an alternating current drive type plasma display panel (AC PDP) having a discharge cell-defining barrier structure formed by an x-y array of T-shape ribs having minimized firing shrinkage distortions, and methods for making such a barrier structure.

### BACKGROUND OF THE INVENTION

Plasma display panels (PDPs) are rapidly becoming one of the more popular types of color display devices used for displaying color images, for example, on computers and televisions, because they are slim, lightweight, and typically have large display screens. PDPs are classified as either a direct current (DC) type or an alternating current (AC) type.

As shown in FIGS. 1A and 3C, a conventional AC PDP may include a front glass substrate 50, a rear glass substrate 10, and a barrier rib structure 20 formed on an inner surface of the rear substrate 10 in display area A thereof. The barrier rib structure 20 may be constructed as an x-y array of T-shaped barrier ribs 30 (best seen in FIG. 1B) each of which is defined by a straight row member 32 and a straight column member 34. In an alternative embodiment, as shown in FIG. 2, the barrier rib structure 20′ may be constructed as an x-y array of Y-shaped barrier ribs 30′ each of which is defined by a bent row member 32′ and a straight column member 34′. The row members 32 and 32′ have respective line widths wᵣ and w_{r′}, and column members 34 and 34′ have respective line widths w_{c} and w_{c′}. The row member line widths wᵣ and w_{r′} are substantially equal to respective column member line widths w_{c} and w_{c′}. The x-y array of barrier ribs 30, 30′ define a plurality of rectangular (FIG. 1B) or hexagonal (FIG. 2) sub-pixel spaces 40, 40′. An AC PDP similar to the one described above having rectangular sub-pixel spaces as shown in FIG. 1B, is described in U.S. Pat. No. 6,373,195. An AC PDP similar to the one described above but with hexagonal sub-pixel spaces as shown in FIG. 2, is described in U.S. Pat. No. 5,317,334.

The above-described barrier rib structures are typically fabricated from a compound of glass powder and oxide material. The barrier rib structure is usually fabricated in a process that includes the steps of coating or printing a layer of the glass powder and oxide compound onto the rear substrate, patterning the coating to define the x-y array of barrier ribs, and then firing the patterned coating.

A problem associated with the fabrication process is that the barrier ribs experience thermal shrinkage during firing. This problem is depicted in FIGS. 3A and 3B wherein FIG. 3A shows one of the barrier ribs 30 before firing and FIG. 3B shows the same barrier rib 30 after firing. The vertical and column members 32, 34 experience substantial shrinkage in the direction of arrow S (FIG. 3A), which distorts the rib 30 as shown in FIG. 3B. This distortion causes the front surface of the row member 32 of the rib 30 to project upwardly towards the front substrate 50 of the AC PDP. This problem is especially critical when very narrow line width barrier ribs are employed in the barrier rib structure. The projection problem is typically seen only on the front surface of the barrier ribs because the rear surface of the ribs are restrained by the rear substrate 10. Thus, when the barrier ribs become distorted, the projection is usually towards the gap h2-h1 between the front substrate 50 and rear substrate 10. The projections can cause a buzzing noise especially at the edge of the display area. At the same time, the shrinkage can allow the gap h2-h1 to become large enough such that an erroneous discharge will be produced in a neighboring sub-pixel cell C1, C2, C3, which produces cross-talk in the display area A.

As shown in FIGS. 5A-5C, the barrier rib structure 20, 20′ are patterned with a zig-zagging edge profile 22, 22′. The zig-zagging edge profiles generate substantial rib shrinkages or distortions in the directions identified by arrows S in FIGS. 5B and 5C, which result in the rib projections described above after firing. In addition to the distortion problems, a certain number of the barrier ribs exhibit open defect problems or breaks after patterning, as shown in FIG. 4. Such defective ribs become distorted after firing also.

### SUMMARY

A method is described for making a sub-pixel barrier structure for a plasma display panel having an array of intersecting barrier rib row and column members. The method comprises the steps of: forming a layer of dielectric material over a substrate; selecting a line width for each of the barrier rib row and column members which minimizes fired shrinkage distortions in the barrier structure; patterning the barrier rib row and column members of the selected line widths in the layer; and firing the substrate.

A method is described for making a sub-pixel barrier structure for a plasma display panel having an array of intersecting barrier rib row and column members. The method comprise the steps of: forming a layer of dielectric material over a substrate; patterning the barrier rib row and column members in the layer; and patterning supplementary barrier rib members in the layer adjacent at least one edge of the barrier structure; and firing the substrate.

A sub-pixel barrier structure is described for a plasma display panel. The barrier structure comprises: a plurality of barrier rib row members, each of the row members having a line width; and a plurality of barrier rib column members intersecting the barrier rib row members, each of the column members having a line width; wherein the line widths of the barrier rib row and column members are selected to minimize fired shrinkage distortions in the barrier structure.

A plasma display panel is described. The plasma display panel comprises: a sub-pixel barrier structure comprising: a plurality of barrier rib row members, each of the row members having a line width; and a plurality of barrier rib column members intersecting the barrier rib row members, each of the column members having a line width; wherein the line widths of the barrier rib row and column members are selected to minimize fired shrinkage distortions in the barrier structure.

A sub-pixel barrier structure is described for a plasma display panel. The barrier structure comprises: a plurality of barrier rib row members; a plurality of barrier rib column members intersecting the barrier rib row members; and supplementary barrier rib members adjacent at least one edge of the barrier structure for minimizing fired shrinkage distortions in the barrier structure.

A plasma display panel is described. The plasma display panel comprises a sub-pixel barrier structure comprising: a plurality of barrier rib row members; a plurality of barrier rib column members intersecting the barrier rib row members; and supplementary barrier rib members adjacent at least one edge of the barrier structure for minimizing fired shrinkage distortions in the barrier structure.

### BRIEF DESCRIPTION OF THE DRAWINGS

FIG. 1A is a plan view of a rear substrate of a conventional AC PDP with an enlarged view of an inner section of an embodiment of a barrier rib structure.

FIG. 1B is a further enlarged, plan view of the section of the barrier rib structure shown in FIG. 1A.

FIG. 2 is a plan view of an inner section of another embodiment of a conventional barrier rib structure.

FIG. 3A is a plan view of a barrier rib of the conventional barrier rib structure of FIG. 1B before firing.

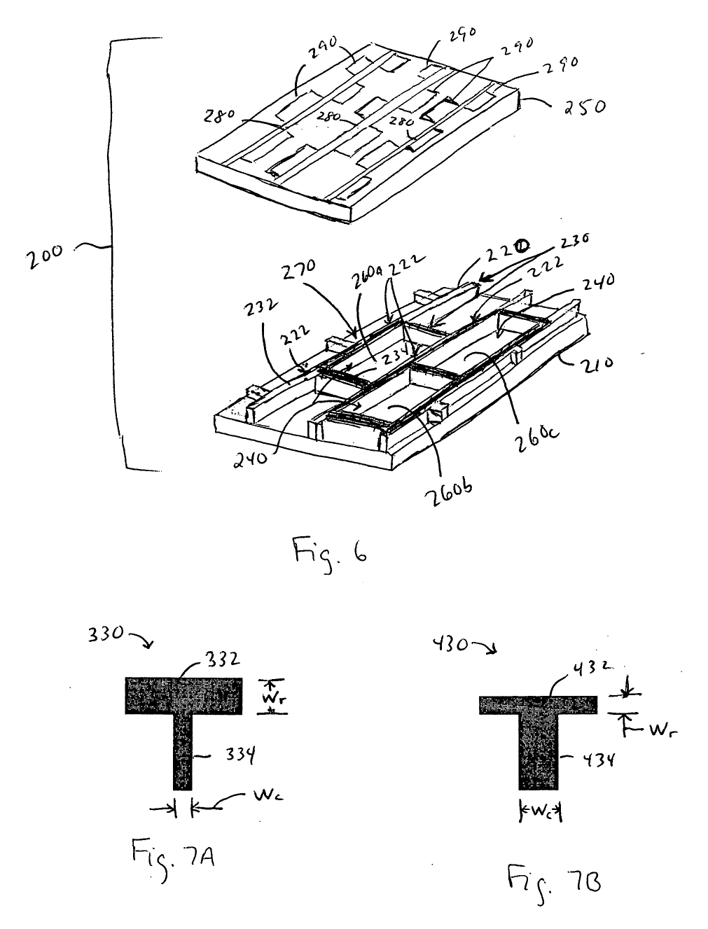

FIG. 3B is a plan view of the barrier rib of FIG. 3A after firing.

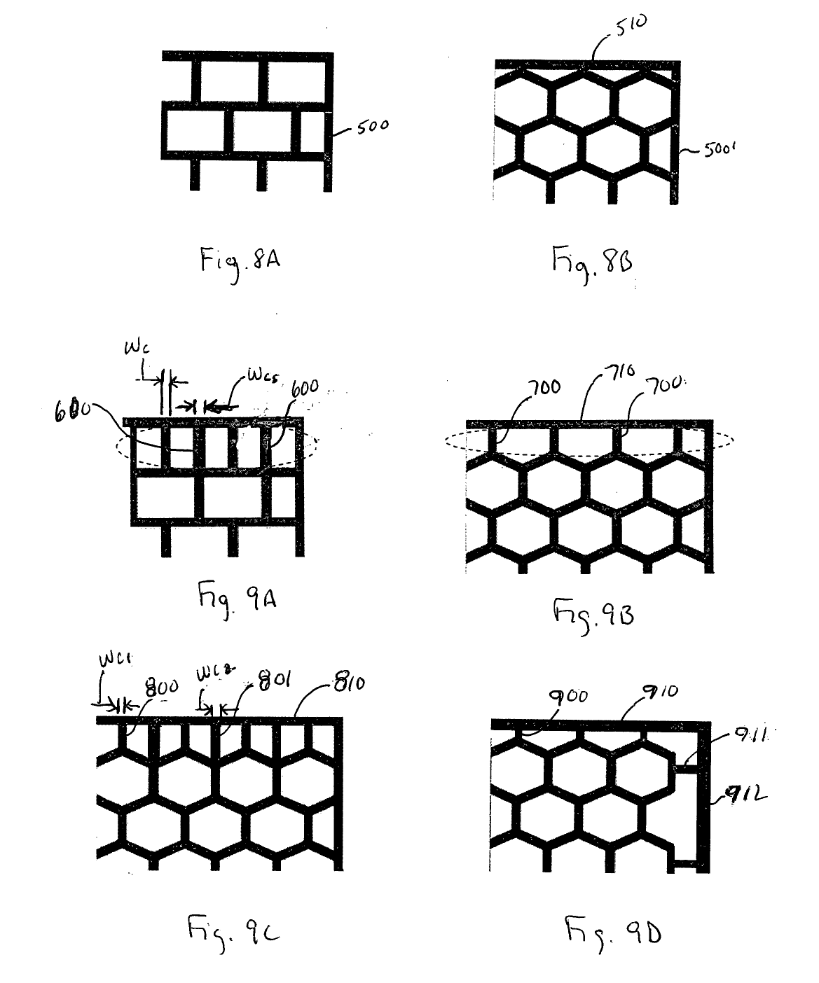

FIG.4is a plan view of a defective barrier rib of the conventional barrier rib structure of FIG. 1B before and after firing.

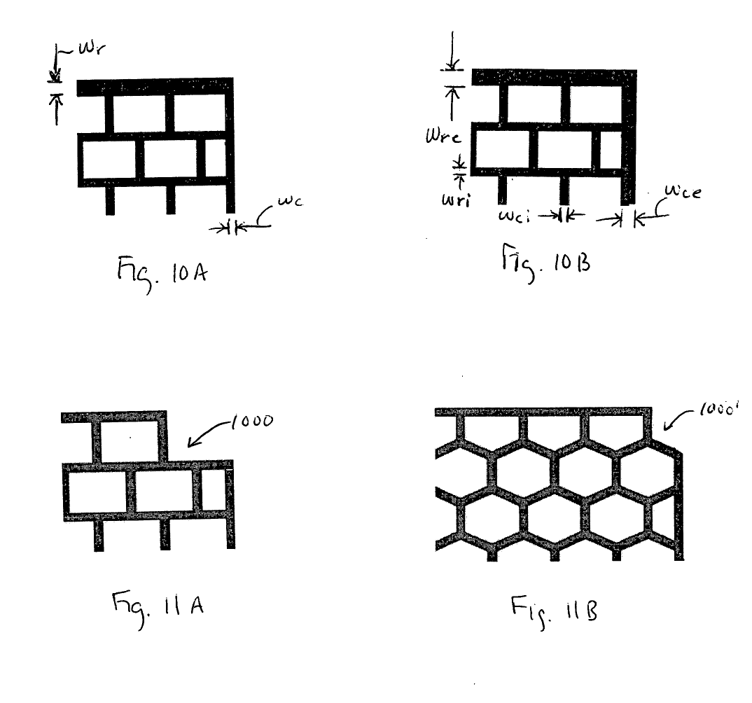

FIG. 5A is a plan view of a rear substrate of the AC PDP of FIG. 1A with an enlarged view of a peripheral section of the barrier rib structure.

FIG. 5B is a further enlarged, plan view of the peripheral section of the barrier rib structure shown in FIG. 5A.

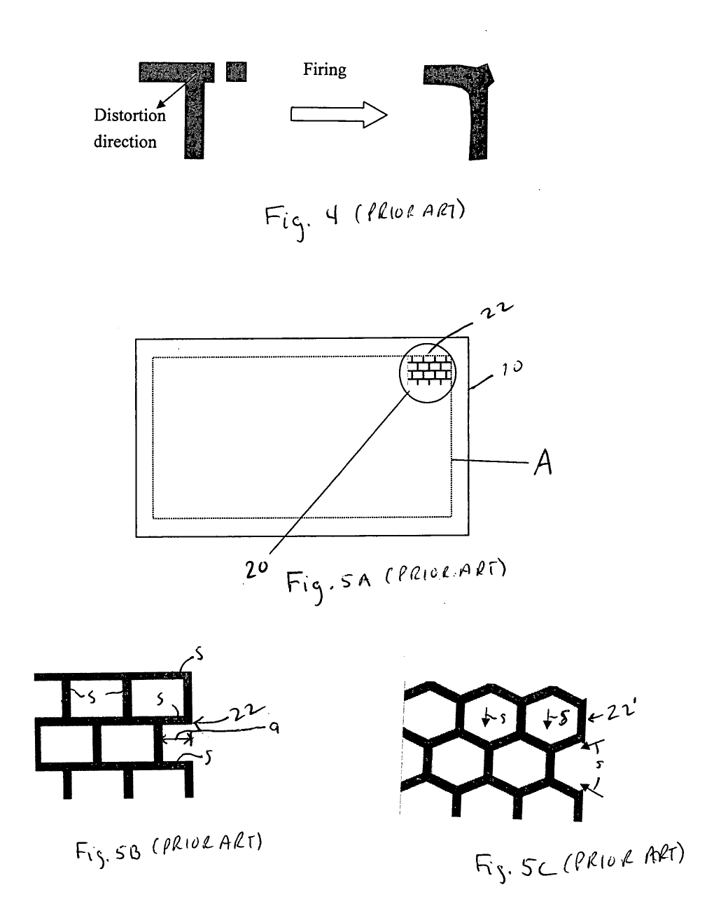

FIG. 2 is a plan view of a peripheral section of the embodiment of the barrier rib structure shown in FIG. 2.

FIG. 6 is a perspective view of an embodiment of an AC PDP according to the present invention.

FIG. 7A is a plan view of an embodiment of a barrier rib according to a first aspect of the present invention.

FIG. 7B is a plan view of another embodiment of a barrier rib according to the first aspect of the present invention.

FIGS. 8A, 8B, 9A-9D, 10A, 10B, 11A, 11B, 12A-12F, and 13A-13C are plan views showing peripheral sections of various embodiments of a barrier rib structure according to a second aspect of the present invention.

### DETAILED DESCRIPTION OF THE INVENTION

FIG. 6 shows an exemplary embodiment of an AC PDP 200 according to the present invention. The AC PDP 200 comprises a rear glass substrate 210 having formed on an inner surface thereof a barrier rib structure 220 defined by an x-y array of T-shaped (shown in FIG. 6) or Y-shaped barrier ribs 230 each of which is defined by a row member 232 and column member 234. The barrier rib row members 232 are arranged parallel to one another, and the barrier rib column members 234 are arranged parallel to one another, and perpendicular to and intersecting the barrier rib row members 232, thereby defining a plurality of square, rectangular (shown in FIG. 6) or hexagonal sub-pixel spaces 240. Address electrodes (not shown) are formed under the sub-pixel spaces 240 and the barrier rib column members 234, and red, green, and blue phosphor layers 260a, 260b, 260c are disposed in adjacent sub-pixel spaces 240 in a delta configuration. Each delta configured group of sub-pixel spaces 240 with red, green, and blue phosphor layers 260a, 260b, 260c forms a color pixel 270. The AC PDP 200 further comprises a transparent front glass substrate 250 having bus electrodes 280 corresponding to and along the barrier rib row members 232, and sustain electrodes 290 disposed over the phosphor-coated sub-pixel spaces 240.

In accordance with a first aspect of the present invention, the barrier ribs 230 of the barrier rib structure 220 may be patterned to provide row members and column members of different line widths. FIG. 7A shows an embodiment a barrier rib 330 according to the present invention wherein the barrier rib row member 332 has a line width wᵣ which is greater than the line width w_{c} of the barrier rib column member 334. FIG. 7B shows another embodiment of a barrier rib 430 wherein the line width w_{c} of the column rib member 434 is greater than the line width wᵣ of the barrier rib row member 432.

Patterning the barrier rib row and column members with different line widths reduces firing shrinkage distortion of the barrier ribs. This in turn reduces the barrier rib projection problem associated with prior art barrier rib structures. Accordingly, the gaps between the front surfaces of the barrier ribs and the front substrate are minimized such that erroneous discharges caused by overly large gaps are substantially reduced or eliminated between neighboring sub-pixel cells resulting in a corresponding reduction or elimination of gap related cross-talk in the display area.

The reduction in firing shrinkage distortion realized from patterning the barrier rib row and column members with different line widths, also reduces the front surface projection problem of prior art barrier rib structures. Hence, the buzzing noise associated with barrier rib front surface projection problems is substantially reduced or eliminated.

Patterning the barrier rib row and column members with different line widths is especially effective for reducing shrinkages and distortions within the inner areas of the barrier rib structure. However, the zig-zagging edge profile of the barrier rib structure generates additional rib shrinkage and distortion problems, because the barrier rib row and column members along the edges of the barrier rib structure are unrestrained, unlike the barrier rib row and column members disposed within the inner areas of the structure.

Hence, in accordance with a second aspect of the invention, the unrestrained barrier rib row and column members forming the edge profile of the barrier rib structure may be restrained by adding supplementary barrier rib members which reduce or eliminate shrinkage and distortion along the periphery thereof after firing. The following discussion provides a few examples of supplementary barrier rib members.

In the rectangular sub-pixel space embodiment of the barrier rib structure shown in FIG. 8A, the barrier rib row and column members forming the edge profile of the barrier rib structure may be restrained by adding supplementary column members 500 to close off open sub-pixel spaces along the edge of the barrier rib structure, thus providing a straight edge profile.

The barrier rib row and column members (including the supplementary column members) forming the edge profile of the barrier rib structure may have different line widths wᵣ and w_{c} as shown in FIG. 10A. In another embodiment, as shown in FIG. 10B, the barrier rib row and column members (including the supplementary column members) forming the edge profile of the barrier rib structure may have respective line widths wᵣₑ and w_{ce} that are each different (greater than in the shown embodiment of FIG. 10B) from the line width wᵣᵢ of the row members and/or line width w_{ci} of the column members defining the inner portion of the barrier rib structure.

In the hexagonal sub-pixel space embodiment shown in FIG. 8B, the barrier rib row and column members forming the edge profile of the barrier rib structure may be restrained by: 1) adding supplementary column members 500′ to close off open sub-pixel spaces along the side edges of the barrier rib structure, thus providing a straight edge profile along this edge, and/or 2) adding an elongated row member 510 along the zig-zagging, outermost row of barrier rib row members, thus providing a straight edge profile along this edge.

FIGS. 9A-9D show other supplementary barrier rib members for restraining the unrestrained barrier rib row and column members forming the edge profile of the barrier rib structure to reduce or eliminate shrinkage and distortion along the periphery thereof after firing. The embodiment shown in FIG. 9A is similar to the embodiment of FIG. 8A, except that supplementary column members 600 are added in the space between the outermost barrier rib column members. The line widths w_{cs} of the supplementary barrier rib column members 600 may be different (greater than, as shown in FIG. 9A) from w_{c} of the column members.

The embodiment shown in FIG. 9B is similar to the embodiment shown in FIG. 8B, except that the barrier rib row members forming the edge profile of the barrier rib structure may be restrained by adding supplementary column members 700 along the outermost row of barrier rib row members, the ends of which are connected together with supplementary elongated row member 710.

The embodiment shown in FIG. 9C is also similar to the embodiment shown in FIG. 8B, except that the barrier rib row members forming the edge profile of the barrier rib structure may be restrained by adding alternating long and short supplementary column members 800, 801 along the outermost row of barrier rib row members, the ends of which are connected together with a supplementary elongated row member 810. The supplementary column members 800 and 801 may have different line widths w_{c1} and w_{c2}, respectively.

In the embodiment of FIG. 9D, the barrier rib row members forming the edge profile of the barrier rib structure may be restrained by adding very short supplementary column members 900 along the outermost row of barrier rib row members, the ends of which are connected together with a supplementary elongated row member 910. The barrier rib row and column members forming the zig-zagging edge profile of the barrier rib structure may be restrained by adding longer supplementary row members 911, the ends of which are connected together with an elongated column member 912.

The embodiments shown in FIGS. 11A and 11B are similar to the respective embodiments of FIGS. 8A and 9B, except that one or more of the corner positions of the barrier rib structure are open, instead of closed to accommodate pumping apertures in the rear substrate 210, which allow air, disposed in the space between the front substrate 250 and the rear substrate 210, to be evacuated.

The embodiments shown in FIGS. 12A-12F are similar to the embodiment of FIG. 8A, except these embodiments further include a restraining lattice structure formed by: one or more supplementary elongated column members 1100 connected by one or more supplementary row members 1110 (FIGS. 12A-12C); supplementary large radius curved members 1200 and supplementary row members 1210 (FIG. 12D); supplementary small radius curved members 1300 (FIG. 12E); and supplementary arrow-head shaped members 1400 (FIG. 12F).

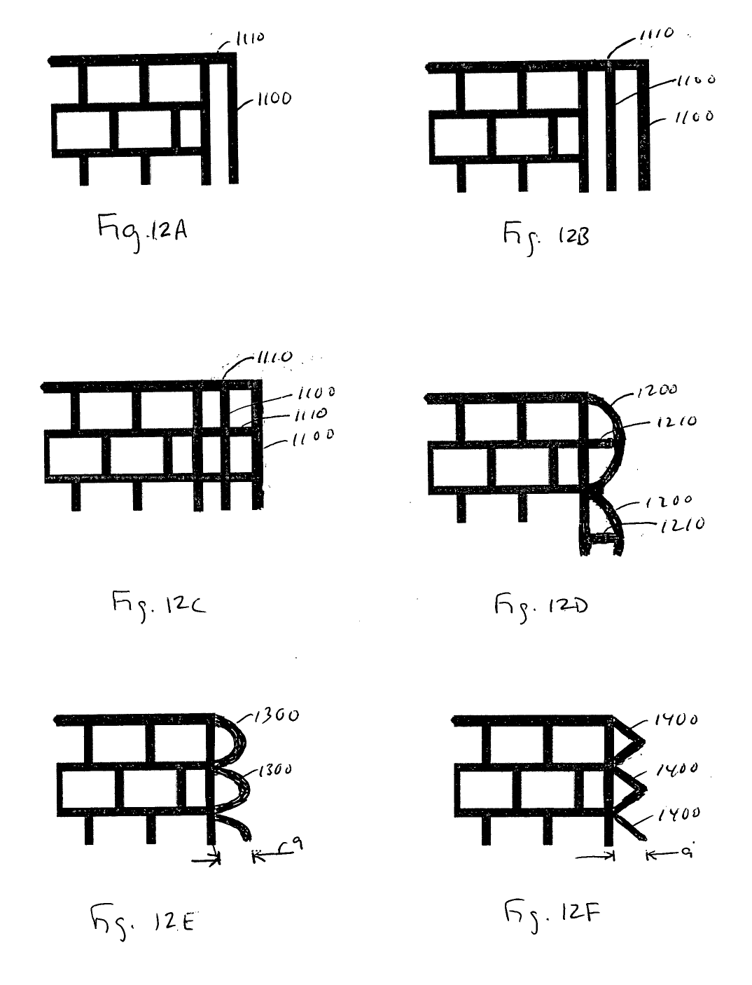

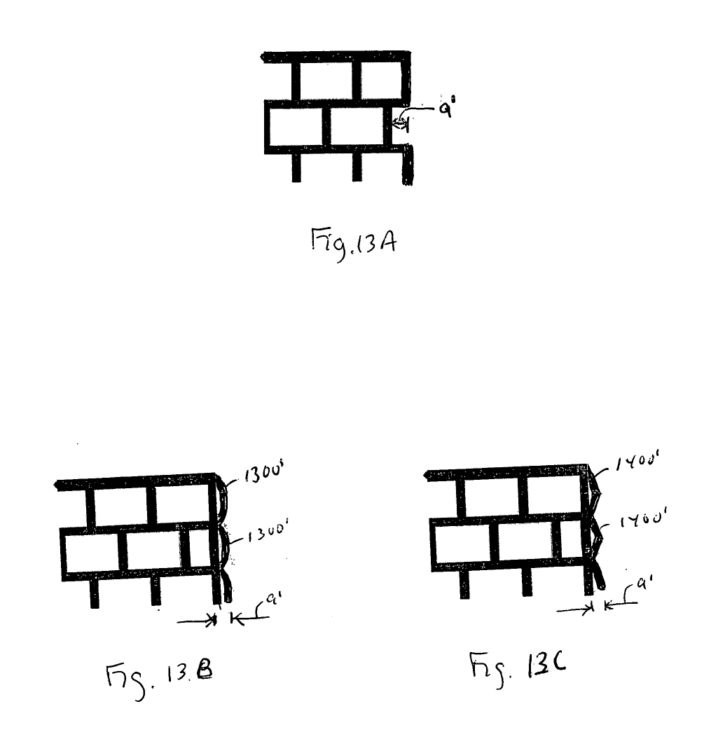

In accordance with a third aspect of the invention, the barrier rib row and column members forming the zig-zagging edge profile can be restrain during firing by reducing the distance a of the zig-zag (FIG. 5B) as shown in FIG. 13A. The outermost row column members forming the zig-zagging edge profile have a shortened zig-zag distance a′.

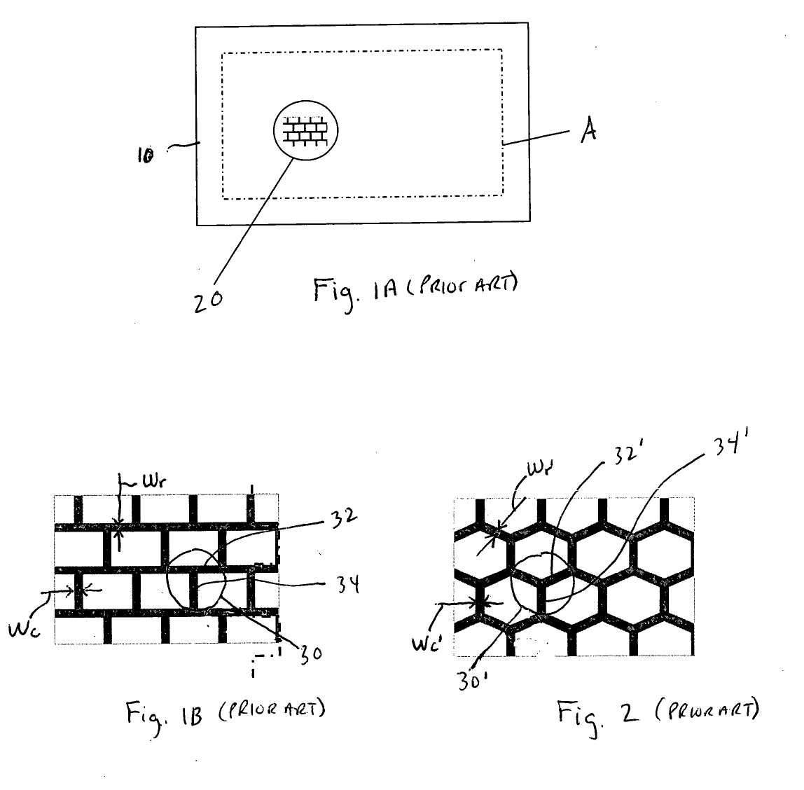

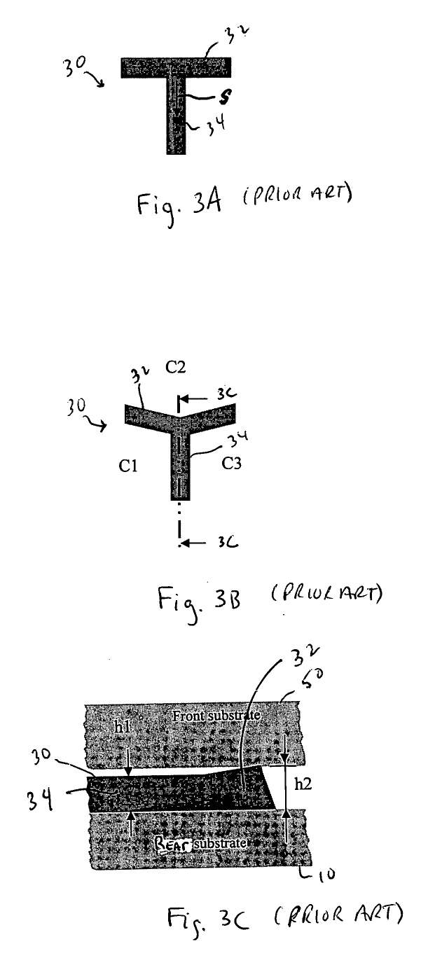

The embodiment shown in FIG. 1 3B is similar to the embodiment of FIG. 12E, except that the curved members 1300′ of the lattice structure define a zig-zagging edge profile which has a shortened zig-zag distance a′. Similarly, the embodiment shown in FIG. 13C is similar to the embodiment of FIG. 12F, except that the arrow-head members 1400′ of the lattice structure define a zig-zagging edge profile which has a shortened zig-zag distance a′.

The barrier rib structures of the present invention may be fabricated from a dielectric material comprising, for example, a compound of glass powder, e.g., SiO₂, and oxide material, e.g., Al₂O₃, B₂O₃, PbO, ZnO, and combinations thereof. The barrier rib structures may be fabricated in a process that includes the steps of coating or printing a layer of the glass powder and oxide compound onto the rear substrate 210, patterning the coating to define the x-y array of barrier ribs, and then firing the patterned coating. The firing may be conducted in an air atmosphere at about 550° C. for about 30 minutes. The firing process can be adjusted according to the composition of the dielectric material.

While the foregoing invention-has been described with reference to the above embodiments, various modifications and changes can be made without departing from the spirit of the invention. Accordingly, all such modifications and changes are considered to be within the scope of the appended claims.

1. A method of making a sub-pixel barrier structure for a plasma display panel, the barrier structure having an array of intersecting barrier rib row and column members, the method comprising the steps of:
forming a layer of dielectric material over a substrate;
selecting a line width for each of the barrier rib row and column members which minimizes fired shrinkage distortions in the barrier structure;
patterning the barrier rib row and column members of the selected line widths in the layer; and
firing the substrate.

2. The method according to claim 1, wherein the line width of at least one of the barrier rib row members is different from the line width of at least one of the barrier rib column members.

3. The method according to claim 1, wherein the line width of at least one of the barrier rib row members at a peripheral location of the barrier structure is different from the line width of at least one of the barrier rib row members not at a peripheral location of the barrier structure.

4. The method according to claim 1, wherein the line width of at least one of the barrier rib column members at a peripheral location of the barrier structure is different from the line width of at least one of the barrier rib column members not at a peripheral location of the barrier structure.

5. The method according to claim 1, wherein the array of intersecting barrier rib row and column members define one of rectangular and square sub-pixel spaces.

6. The method according to claim 1, wherein the array of intersecting barrier rib row and column members define hexagonal sub-pixel spaces.

7. The method according to claim 1, wherein the patterning step includes patterning supplementary barrier rib members adjacent at least one edge of the barrier structure.

8. The method according to claim 7, wherein the supplementary barrier rib members close open sub-pixels spaces disposed along the at least one edge of the barrier structure.

9. The method according to claim 7, wherein the selecting step includes selecting a line width for each of the supplementary barrier rib members, which minimizes fired shrinkage distortions at a periphery of the barrier structure.

10. The method according to claim 7, wherein at least one of the supplementary barrier rib members includes a supplementary barrier rib column member.

11. The method according to claim 10, wherein the at least supplementary barrier rib column member is disposed between adjacent barrier rib column members.

12. The method according to claim 7, wherein at least one of the supplementary barrier rib members includes a supplementary barrier rib row member.

13. The method according to claim 7, wherein at least one of the supplementary barrier rib members includes an elongated barrier rib member.

14. The method according to claim 7, wherein at least one of the supplementary barrier rib members includes an elongated barrier rib column member.

15. The method according to claim 7, wherein at least one of the supplementary barrier rib members includes an elongated barrier rib row member.

16. The method according to claim 7, wherein at least one of the supplementary barrier rib members is shorter in length than at least another one of the supplementary barrier rib members.

17. The method according to claim 7, wherein at least two of the supplementary barrier rib members are supplementary barrier rib column members and at least another two of the supplementary barrier rib members are supplementary barrier rib row members, the at least two supplementary barrier rib column members being shorter in length than the at least two supplementary barrier rib row members.

18. The method according to claim 17, wherein at least a further one of the supplementary barrier rib members includes an elongated barrier rib column member and at least a further one of the supplementary barrier rib members includes an elongated barrier rib row member, the at least two supplementary barrier rib column members being attached at ends thereof by the elongated barrier rib row member and the at least two supplementary barrier rib row members being attached at ends thereof by the elongated barrier rib column member.

19. The method according to claim 7, wherein at two of the supplementary barrier rib members are supplementary barrier rib column members and at least another two of the supplementary barrier rib members are supplementary barrier rib row members, the at least two supplementary barrier rib row members being shorter in length than the at least two supplementary barrier rib column members.

20. The method according to claim 19, wherein at least a further one of the supplementary barrier rib members includes an elongated barrier rib column member and at least a further one of the supplementary barrier rib members includes an elongated barrier rib row member, the at least two supplementary barrier rib column members being attached at ends thereof by the elongated barrier rib row member and the at least two supplementary barrier rib row members being attached at ends thereof by the elongated barrier rib column member.

21. The method according to claim 7, wherein at least one of the supplementary barrier rib members is disposed between adjacent ones of the barrier rib column members.

22. The method according to claim 21, wherein the at least one of the supplementary barrier rib members disposed between adjacent ones of the barrier rib column members is longer than the barrier rib column members.

23. The method according to claim 7, wherein the supplementary barrier rib members close open sub-pixels spaces disposed along the at least one edge of the barrier structure except at least one corner thereof.

24. The method according to claim 7, wherein at least one of the supplementary barrier rib members provides an edge of the barrier structure with a straight profile.

25. The method according to claim 7, wherein at least two of the supplementary barrier rib members are elongated barrier rib members.

26. The method according to claim 25, wherein the elongated barrier rib members are connected to the barrier rib structure by at least two of the other supplementary barrier rib members.

27. The method according to claim 7, wherein at least one of the supplementary barrier rib members includes a curved member.

28. The method according to claim 27, wherein at least another one of the supplementary barrier rib members extends radially from the barrier rib structure to the curved member.

29. The method according to claim 7, wherein at least one of the supplementary barrier rib members includes a arrow head member.

30. The method according to claim 1, wherein the patterning step includes patterning at least one edge of the barrier structure with a reduced zig-zagging edge profile.

31. The method according to claim 7, wherein the line width of at least one of the supplementary barrier rib members is different from the line width of at least one of the barrier rib row members.

32. The method according to claim 7, wherein the line width of at least one of the supplementary barrier rib members is different from the line width of at least one of the barrier rib column members.

33. The method according to claim 7, wherein the line width of at least one of the supplementary barrier rib members is different from the line width of at least another one of the supplementary barrier rib members.

34. The method according to claim 7, wherein the supplementary barrier rib members provide at least one edge of the barrier structure with a straight profile.

35. A method of making a sub-pixel barrier structure for a plasma display panel, the barrier structure having an array of intersecting barrier rib row and column members, the method comprising the steps of:
forming a layer of dielectric material over a substrate;
patterning the barrier rib row and column members in the layer; and
patterning supplementary barrier rib members in the layer adjacent at least one edge of the barrier structure; and
firing the substrate.

36. The method according to claim 35, wherein the supplementary barrier rib members close open sub-pixels spaces disposed along the at least one edge of the barrier structure.

37. The method according to claim 35, wherein the selecting step includes selecting a line width for each of the supplementary barrier rib members, which minimizes fired shrinkage distortions at a periphery of the barrier structure.

38. The method according to claim 35, wherein at least one of the supplementary barrier rib members includes a supplementary barrier rib column member.

39. The method according to claim 38, wherein the at least supplementary barrier rib column member is disposed between adjacent barrier rib column members.

40. The method according to claim 35, wherein at least one of the supplementary barrier rib members includes a supplementary barrier rib row member.

41. The method according to claim 35, wherein at least one of the supplementary barrier rib members includes an elongated barrier rib member.

42. The method according to claim 35, wherein at least one of the supplementary barrier rib members includes an elongated barrier rib column member.

43. The method according to claim 35, wherein at least one of the supplementary barrier rib members includes an elongated barrier rib row member.

44. The method according to claim 35, wherein at least one of the supplementary barrier rib members is shorter in length than at least another one of the supplementary barrier rib members.

45. The method according to claim 35, wherein at least two of the supplementary barrier rib members are supplementary barrier rib column members and at least another two of the supplementary barrier rib members are supplementary barrier rib row members, the at least two supplementary barrier rib column members being shorter in length than the at least two supplementary barrier rib row members.

46. The method according to claim 45, wherein at least a further one of the supplementary barrier rib members includes an elongated barrier rib column member and at least a further one of the supplementary barrier rib members includes an elongated barrier rib row member, the at least two supplementary barrier rib column members being attached at ends thereof by the elongated barrier rib row member and the at least two supplementary barrier rib row members being attached at ends thereof by the elongated barrier rib column member.

47. The method according to claim 35, wherein at two of the supplementary barrier rib members are supplementary barrier rib column members and at least another two of the supplementary barrier rib members are supplementary barrier rib row members, the at least two supplementary barrier rib row members being shorter in length than the at least two supplementary barrier rib column members.

48. The method according to claim 47, wherein at least a further one of the supplementary barrier rib members includes an elongated barrier rib column member and at least a further one of the supplementary barrier rib members includes an elongated barrier rib row member, the at least two supplementary barrier rib column members being attached at ends thereof by the elongated barrier rib row member and the at least two supplementary barrier rib row members being attached at ends thereof by the elongated barrier rib column member.

49. The method according to claim 35, wherein at least one of the supplementary barrier rib members is disposed between adjacent ones of the barrier rib column members.

50. The method according to claim 49, wherein the at least one of the supplementary barrier rib members disposed between adjacent ones of the barrier rib column members is longer than the barrier rib column members.

51. The method according to claim 35, wherein the supplementary barrier rib members close open sub-pixels spaces disposed along the at least one edge of the barrier structure except at least one corner thereof.

52. The method according to claim 35, wherein at least one of the supplementary barrier rib members provides an edge of the barrier structure with a straight profile.

53. The method according to claim 35, wherein at least two of the supplementary barrier rib members are elongated barrier rib members.

54. The method according to claim 53, wherein the elongated barrier rib members are connected to the barrier rib structure by at least two of the other supplementary barrier rib members.

55. The method according to claim 35, wherein at least one of the supplementary barrier rib members includes a curved member.

56. The method according to claim 55, wherein at least another one of the supplementary barrier rib members extends radially from the barrier rib structure to the curved member.

57. The method according to claim 35, wherein at least one of the supplementary barrier rib members includes a arrow head member.

58. The method according to claim 35, wherein the patterning step includes patterning at least one edge of the barrier structure with a reduced zig-zagging edge profile.

59. The method according to claim 35, wherein the line width of at least one of the supplementary barrier rib members is different from the line width of at least another one of the supplementary barrier rib members.

60. The method according to claim 35, wherein the supplementary barrier rib members provide at least one edge of the barrier structure with a straight profile.

61. A sub-pixel barrier structure for a plasma display panel, the barrier structure comprising:
a plurality of barrier rib row members, each of the row members having a line width; and
a plurality of barrier rib column members intersecting the barrier rib row members, each of the column members having a line width;
wherein the line widths of the barrier rib row and column members are selected to minimize fired shrinkage distortions in the barrier structure.

62. A plasma display panel comprising:
a sub-pixel barrier structure comprising:
a plurality of barrier rib row members, each of the row members having a line width; and
a plurality of barrier rib column members intersecting the barrier rib row members, each of the column members having a line width;
wherein the line widths of the barrier rib row and column members are selected to minimize fired shrinkage distortions in the barrier structure.

63. A sub-pixel barrier structure for a plasma display panel, the barrier structure comprising:
a plurality of barrier rib row members;
a plurality of barrier rib column members intersecting the barrier rib row members; and
supplementary barrier rib members adjacent at least one edge of the barrier structure for minimizing fired shrinkage distortions in the barrier structure.

64. A plasma display panel comprising:
a sub-pixel barrier structure comprising:
a plurality of barrier rib row members;
a plurality of barrier rib column members intersecting the barrier rib row members; and
supplementary barrier rib members adjacent at least one edge of the barrier structure for minimizing fired shrinkage distortions in the barrier structure.
